(19) United States
(12) Patent Application Publication
(10) Pub. No.: US 2019/0266883 A1
(43) Pub. Date: Aug. 29, 2019

(54) System and Method for Providing Emergency Alerts

(71) Applicant: Patrick J. Flynn, Racine, WI (US)

(72) Inventor: Patrick J. Flynn, Racine, WI (US)

(21) Appl. No.: 16/283,348

(22) Filed: Feb. 22, 2019

Related U.S. Application Data
(60) Provisional application No. 62/636,714, filed on Feb. 28, 2018.

(51) Int. Cl. G08B 27/00; H04W 4/90

(52) U.S. Cl. CPC G08B 27/001; H04W 4/90

(57) ABSTRACT

A method to send emergency alerts to 911 first responders specifies category of emergency and level of threat. A user can choose one of the emergency categories including police, fire, medical, and marine, and one of various levels of threat such as low, medium, high, and life-threatening for each category of emergency. Then the user sends the alert to the 911 first responder together with the user specific personal information including name, physical address, GPS coordinates, contact phone number, emergency contact person's name and phone number, relationship of the emergency contact person to the user, etc. The 911 first responder can dispatch the corresponding emergency personnel to the user's address and can connect to the user and view the user's surroundings through the camera of the user's personal computing (PC) device. The system and method can be used in a home, outdoors such as a park, a public building such as library, school, beach, boat, etc.

The current application claims a priority to the U.S. Provisional Patent application Ser. No. 62/636,714 filed on Feb. 28, 2018.

### FIELD OF THE INVENTION

The present invention relates generally to the field of emergency services. More specifically, the present invention is a system and method for providing emergency alerts to first responders for users in dangerous and disastrous situations such as burglary, fire, drowning, and any other life-threatening (e.g. heart attack, fall) emergencies.

### BACKGROUND OF THE INVENTION

An emergency response system, also known as a medical alert system, offers a user a fast and easy way to notify emergency service personnel when assistance is needed. Many emergency response systems include a device with a button worn around the user's neck like a pendant, or wrist like a watch. The device may also include pull cords and other actuators to send an alert to the emergency service provider. These systems are invaluable for those users who live alone and who are elderly with health issues to get help during an emergency, whether it be a medical issue, a fall, a fire, or any event that requires immediate assistance.

Most basic systems use a landline and comprise a base unit and a portable device with a help button on the portable device. There are cellular options and GPS (global positioning system) based mobile solutions for the users on the go. To call for help in an emergency, the user simply presses the help button on the portable device. The base unit is immediately activated to automatically dial up the emergency response service center associated with the alert service provider. Normally, after 20 to 40 seconds, a live agent answers the call. The base unit acts as a hands-free speakerphone through which the user can communicate with the emergency response agent and request help. If emergency help is requested, the emergency response agent will call 911 and have an emergency responder dispatched to the user's physical address. The emergency response agent may contact any emergency contact person the user specified and saved in the user's personal account registered with the emergency response service provided.

However, many existing personal emergency response systems have drawbacks and problems. Most personal emergency systems need a piece of equipment and a portable device worn by a user. Some of the portable devices are not comfortable to wear and some need charging daily. In the daily use, the portable device may go out of range of the service provided through the base unit equipment. Emergency alerts do not go to 911 dispatchers directly, rather to an emergency response service center, for which the user needs to sign up for a service plan and stay in plan with a fee-paying contract. In a catastrophic or life-threatening emergency, the user may not get the life-saving help fast enough since the service center may need to diagnose the situation and then to call 911. Additionally, the costs to the user are also high. These costs include system activation fee, monthly fee, cellular fee, etc. Further, the portable device may send false alerts to the service responder, get damaged or lost, and some devices are not reliable—faulty at times.

Thus, it the objective of the present invention to solve the aforementioned problems and drawbacks of the existing emergency response systems. The present invention is a system and method for providing the user with a fast and efficient way to send emergency alerts directly to 911 first responders under any life-threatening and/or catastrophic situations. Additionally, the present invention enables the user to send the emergency alert to the 911 first responder with sufficient information such as category of emergency and level of threat to minimize the time for the first responder to make the decision to dispatch the right emergency assistance personnel to help the user. Additionally, the method allows the user to enter special needs for the victim, wherein the victim may be the specific user or any person the specific user is trying to help in the emergency. The special needs include, but are not limited to, allergy to medicine, the victim being deaf or an autistic child, etc. Further, the present invention can be used by the user at home, in a public place such as a park or a library, a school building, in a fire, in a marine situation such as on a boat, swimming, etc. The present invention offers the user multiple options to connect to 911 first responders through a landline telephone service line, cellular service, Wi-Fi communication, etc.

### SUMMARY OF THE INVENTION

A system and method for sending alerts to 911 first responders in an emergency enables a user to specify category of emergency and level of threat. The user can choose one of the emergency categories including, but not limited to, police, fire, medical, and marine. Various levels of threat including, but not limited to, low, medium, high, and life-threatening are included for each category of emergency. The user chooses a category of emergency and a specific threat level associated with the emergency. Then the user sends the alert to the 911 first responder together with the user specific personal information including, but not limited to, name, physical address, GPS coordinates, contact phone number, emergency contact person's name and phone number, relationship of the emergency contact person to the user, etc. The personal information is specified and saved in the system by the user during system setup. The 911 first responder can dispatch the corresponding emergency personnel to the user's address or can connect to the user and view the user's surroundings through the camera of the user's personal computing device. Additionally, the 911 first responder can communicate with the user through the phone number provided in the emergency alert. Thus, the system and method can be used by the user in a home, outdoors such as a park, a public building such as library, school, beach, boat, etc. The user can also send the emergency alert to 911 first responders in the shortest time by three simple taps on the user's PC device without specifying the category of emergency and level of threat. Subsequently, the 911 first responder can call the user and/or the user's emergency contact person through the personal information in the emergency alert received. Further, the user can specify any special needs for the victim in the emergency while the victim can be the specific user, or any person the specific user is trying to help using the present invention. The specific need includes medicine allergy information, victim being deaf or an autistic child, etc.

### BRIEF DESCRIPTION OF THE DRAWINGS

FIG. 1 is a block diagram illustrating the system overview of the present invention.

FIG. 2 is a flowchart illustrating the overall process followed by the method of the present invention.

FIG. 3 is a flowchart illustrating a sub-process for setting up personal information of a specific user account of the present invention.

FIG. 4 is a flowchart illustrating a sub-process for sending emergency alerts with special needs of the present invention.

FIG. 5 is a flowchart illustrating a sub-process for sending emergency alerts through a bypass of the present invention.

FIG. 6 is a flowchart illustrating a sub-process for providing a bypass interface used in the bypass sup-process illustrated in FIG. 5 of the present invention.

FIG. 7 is a flowchart illustrating a sub-process for providing communications between the specific first responder and the specific user of the present invention.

### DETAIL DESCRIPTIONS OF THE INVENTION

All illustrations of the drawings are for the purpose of describing selected versions of the present invention and are not intended to limit the scope of the present invention.

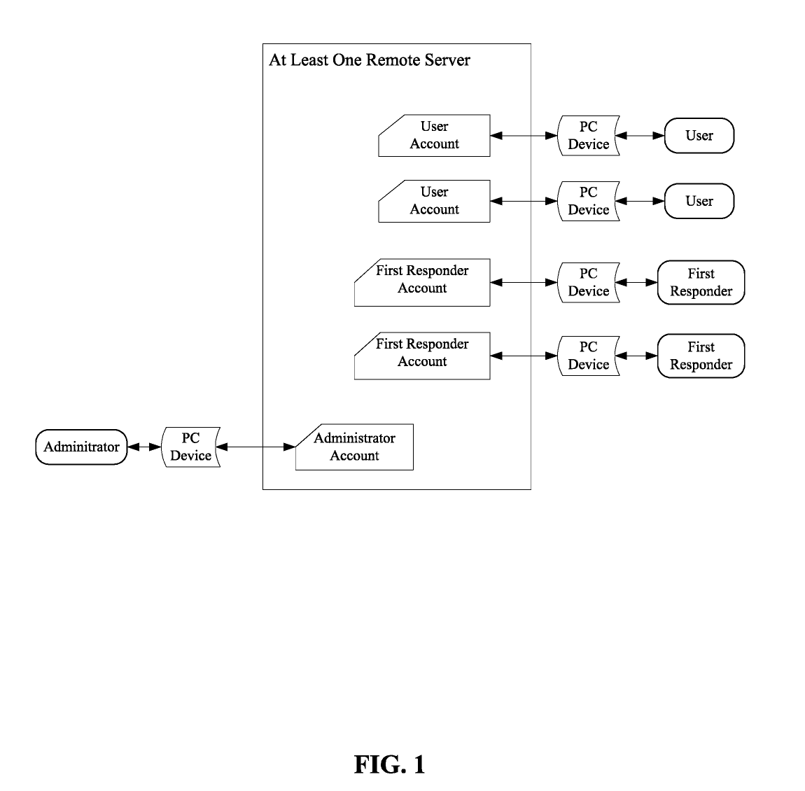

As can be seen in FIG. 1 to FIG. 7, the present invention is a system and method for providing the user with a fast and efficient way to send emergency alerts directly to 911 first responders under any life-threatening and/or catastrophic situations. Additionally, the present invention enables the user to send the emergency alerts to the 911 first responder with sufficient information such as category of emergency and level of hazard to minimize the time for the first responder to make the decision to dispatch the right emergency assistance personnel to help the user. Further, the present invention can be used by the user at home, in a public place such as a park or a library, a school building, in a fire, in a marine situation such as on a boat, swimming, etc. The present invention offers the user multiple options to connect to 911 first responders through a landline telephone service line, cellular service, Wi-Fi communication, etc.

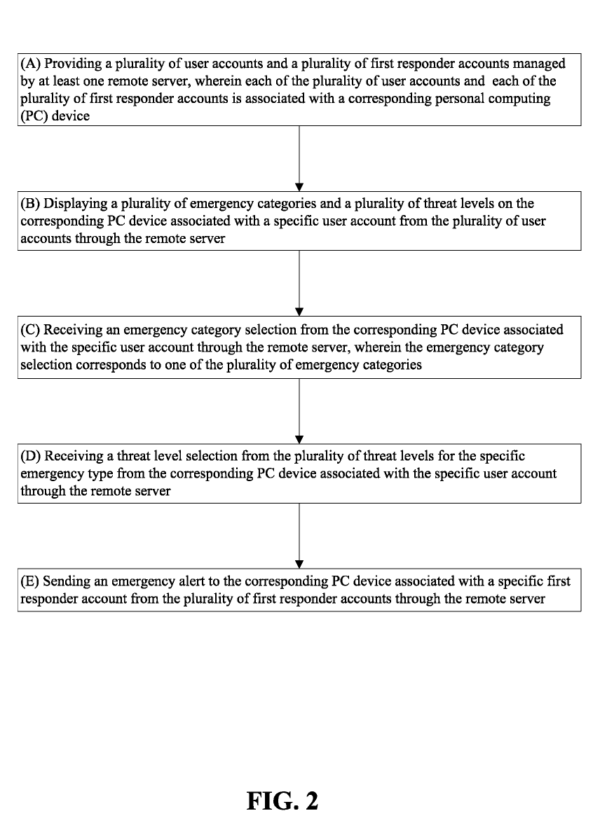

As can be seen in FIG. 1, the method of the present invention provides a system to manage the emergency alerts between a plurality of users and a plurality of first responders. To accomplish this, the method of the present invention associates each of the plurality of users with a unique user account from a plurality of user accounts and each of the plurality of first responders with a unique first responder account from a plurality of first responder accounts that are managed by at least one remote server (Step A) as seen in FIG. 2. Each of the plurality of user accounts and each of the plurality of first responder accounts is associated with a corresponding personal computing (PC) device. The corresponding PC device allows a user and/or a first responder to interact with the present invention and can be, but is not limited to, a smartphone, a smart watch, a laptop, a desktop, or a tablet PC. The users of the user accounts may include relevant parties such as, but are not limited to, individuals, consumers, corporations, school teachers, school principals, government workers and officials, and administrators. The first responders of the first responder accounts may include relevant parties such as, but are not limited to, police dispatch personnel, law enforcement personnel such as police, medical response personnel, ambulance responders, fire department, life rescuers, and administrators. Further, the at least one remote server is used to manage the emergency alert platform for the plurality of user accounts. The remote server can be managed through an administrator account by an administrator as seen in FIG. 1. Moreover, the remote server is used to execute a number of internal software processes and store data for the present invention. The software processes may include, but are not limited to, server software programs, web-based software applications or browsers embodied as, for example, but not be limited to, websites, web applications, desktop applications, and mobile applications compatible with a corresponding user PC device. Additionally, the software processes may store data into internal databases and communicate with external databases, which may include but are not limited to map databases (such as Google Maps®), personal information databases, databases maintaining data about schools, parks, public facilities, government buildings, libraries, etc. The interaction with external databases over a communication network may include, but is not limited to, the Internet.

As can be seen in FIG. 2, the overall process of the method of the present invention displays a plurality of emergency categories and a plurality of threat levels on the corresponding PC device associated with a specific user account from the plurality user accounts through the remote server (Step B). More specifically, the emergency categories of the present invention include, but are not limited to, police, ambulance, fire, marine, etc. Police relates to any kind of property trespassing, home break-in, burglary, thief, robbery, domestic abuse, violence, murder, etc. Ambulance includes, but is not limited to, medical emergency, heart attack, stroke, fall, etc. Further, marine category of emergency includes, but is not limited to, drowning in water such as pool, pond, lake, river, ocean, emergency situations on a boat, sailing, etc. Additionally, each specific emergency category includes a plurality of threat levels including, but not limited to, low, medium, high, life-threatening, etc. Once the specific user associated with the specific user account makes an emergency category selection, the specific emergency category selection is sent to the remote server. Subsequently, the method receives the emergency category selection from the corresponding PC device associated with the specific user account through the remote server, wherein the emergency category selection corresponds to one of the plurality of emergency categories (Step C). Further, the specific user selects a threat level, and the method receives the threat level selection from the plurality of threat levels for the specific emergency category from the corresponding PC device associated with the specific user account through the remote server (Step D). Finally, the specific user activates the alert transmitting interface, and the method sends an emergency alert to the corresponding PC device associated with a specific first responder account from the plurality of first responder accounts through the remote server (Step E). The emergency alert message sent by the method comprises a format including, but not limited to, “This is an Emergency Alert Call from (the user's address) and/or (GPS coordinates)—The emergency is (the specific emergency category)—The threat level is (the specific threat level). To contact the user, call xxx.xxx.xxxx. To contact the user's emergency contact person (name and relation to the user), call yyy.yyy.yyyy.” In other embodiments, the present invention may comprise an alert format including, but not limited to, “This is an Emergency Alert Call from (the user's address) and/or (GPS coordinates). To contact the user, call xxx.xxx.xxxx.” The method combines specific user's person information with the specific emergency category and the specific threat level into one alert message which is sent to the first responder associated with a specific first responder account from the plurality of first responder accounts. Further, the personal information of the specific user account is entered and saved to the system of the present invention through a sub-process during the account setup by the specific user.

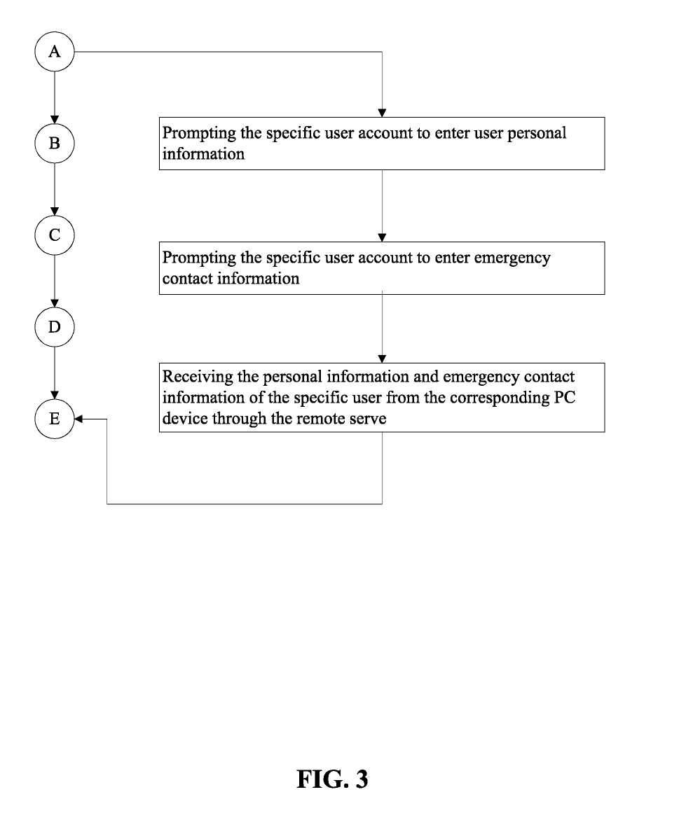

As can be seen in FIG. 3, the method of the present invention provides a sub-process to the specific user to set up the corresponding user account including, but not limited to, personal information and emergency contact information for the corresponding user account. More specifically, the method prompts the specific user account to enter personal information. This step is usually conducted at the first time the specific user uses the method. Additionally, the method prompts the specific user to enter emergency contact information. Both setup steps for the specific user account can be done at a later time if the specific user prefers to do so. Once the specific information is entered by the specific user with the corresponding PC device, the method receives the information through the remote server. Further, the personal information and emergency contact information for the specific user account can be used in every emergency alert message sent by the method to any of the plurality of first responder accounts.

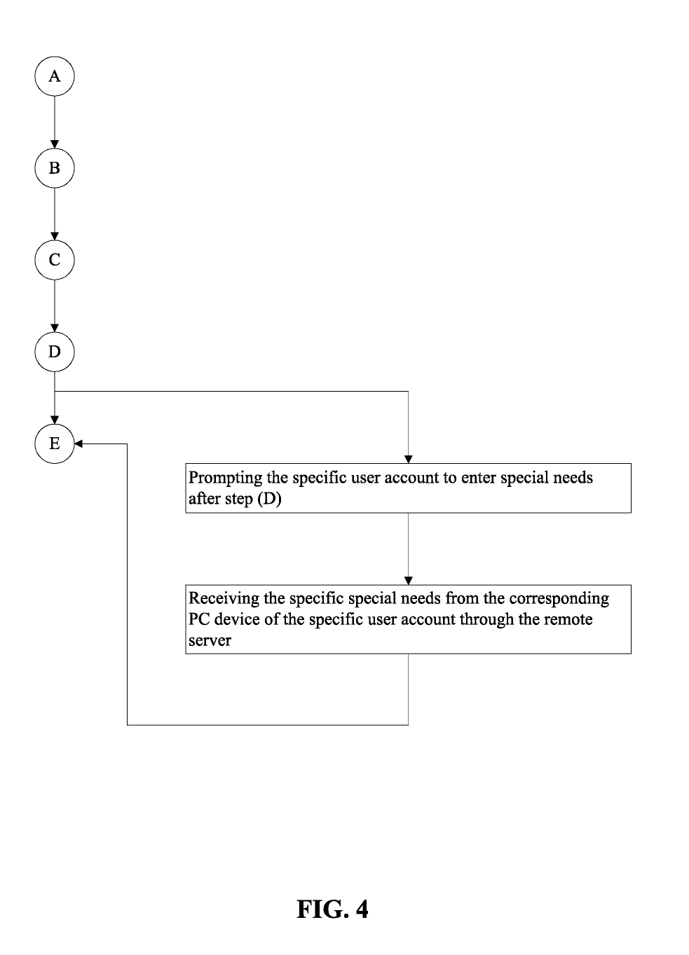

As can be seen in FIG. 4, the method of the present invention provides a sub-process to the specific user to send an emergency alert to a first responder with special needs. More specifically, the method prompts the specific user account to enter special needs after Step D. The special needs are for a victim in the emergency. The victim can be the specific user themselves, a family member of the specific user, or any person the specific user is helping in the emergency. Subsequently, the method receives through the specific special needs from the corresponding PC device of the specific user account through the remote server. The alert message in this case includes the specific special needs for the victim in the emergency, which are specified by the specific user. Additionally, the special needs may include, but are not limited to, allergic reactions to the medicine, an autistic child, deaf person, or any other special need.

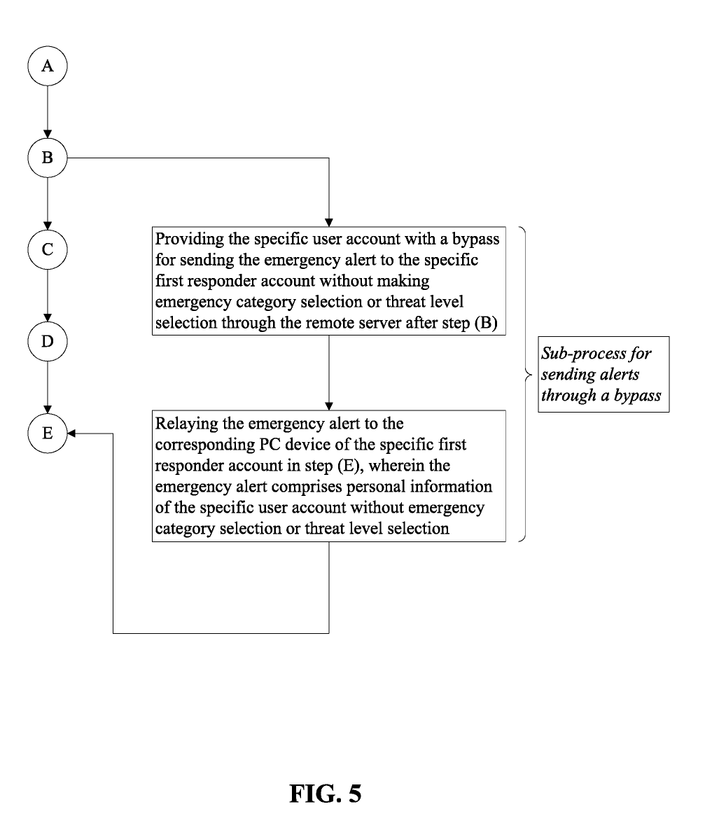

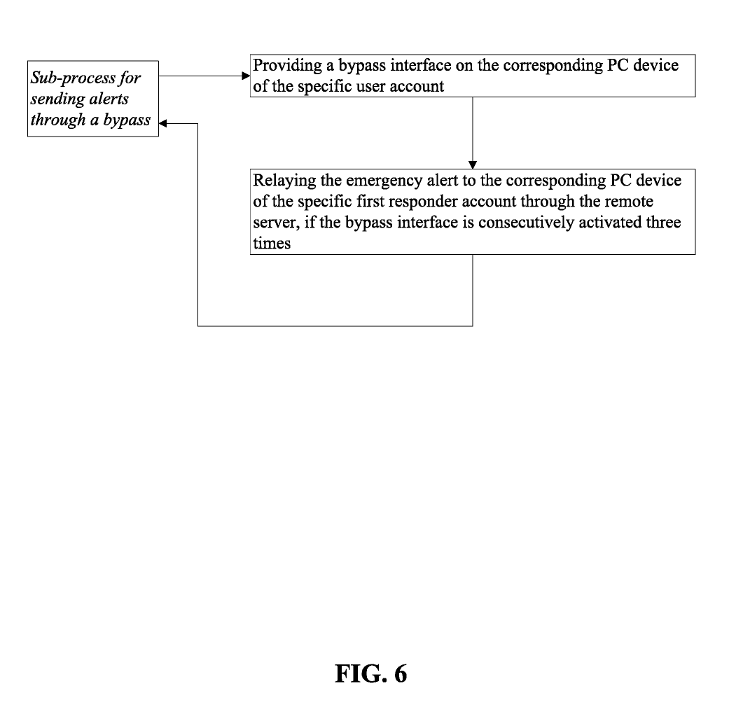

As can be seen in FIG. 5, the method of the present invention provides a sub-process to the specific user to bypass the steps for selecting an emergency category and associated threat level, thus, the emergency alert can be sent to a first responder more rapidly than the overall process of the present invention. More specifically, the method provides the specific user account with the bypass for sending an emergency alert to the specific first responder account without making emergency category selection or threat level selection through the remote server after Step B. Subsequently, the method relays the emergency alert to the corresponding PC device of the specific first responder account in Step E, wherein the emergency alert comprises personal information of the specific user account without emergency category selection or threat level selection. The personal information included in the emergency alert message was set up during the account setup sub-process described above. The alert message in this case does not include the specific information regarding the emergency category or threat level. In another embodiment of the present invention, as seen in FIG. 6, the method of the present invention provides a bypass interface on the corresponding PC device of the specific user account in the bypass sub-process. Subsequently, the method relays the emergency alert to the corresponding PC device of the specific first responder account through the remote server, if the bypass interface is consecutively activated three times. The bypass interface can be the same interface or control that the method provides to the specific user on the corresponding PC device for sending emergency alerts. The bypass interface and the interface for sending emergency alerts of the present invention can be, but are not limited to, a button, a graphical control, an actuator, a turn knob, or any other suitable control, etc. However, other suitable categories of control and/or button may be used for the present invention.

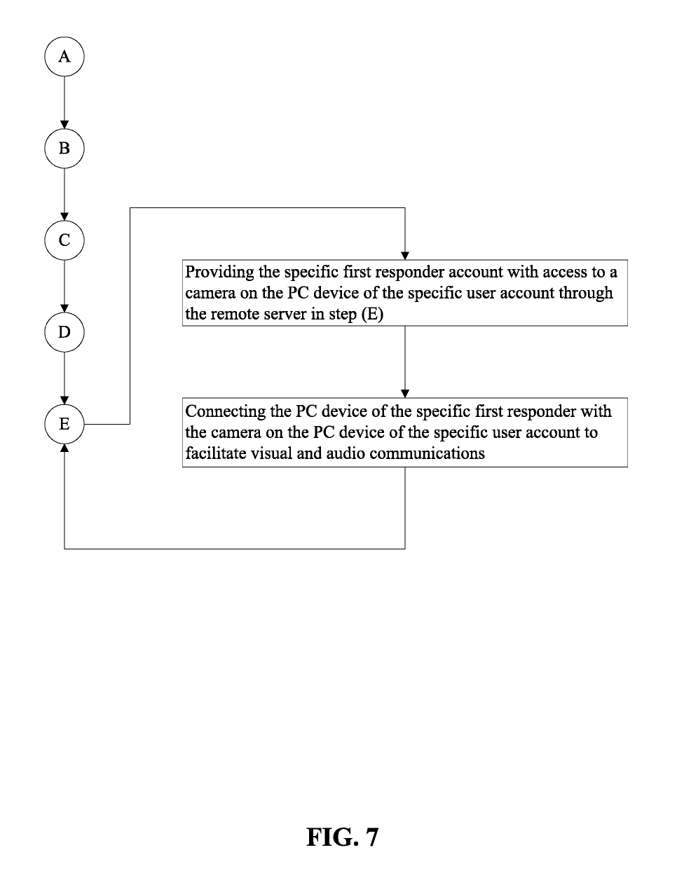

As can be seen in FIG. 7, the method of the present invention provides a sub-process to facilitate communications between the specific first responder and the specific user in the emergency. More specifically, the method provides the specific first responder account with access to a camera on the PC device of the specific user account through the remote server in Step E. Subsequently, the method connects the PC device of the specific first responder with the camera on the PC device of the specific user account to facilitate visual and audio communications. This sub-process helps the specific first responder to understand the emergency, view the surroundings of the specific user, and communicate with the specific user.

Although the invention has been explained in relation to its preferred embodiment, it is to be understood that many other possible modifications and variations can be made without departing from the spirit and scope of the invention as hereinafter claimed.

What is claimed is:

1. A method for providing emergency alerts comprising the steps of:
(A) providing a plurality of user accounts and a plurality of first responder accounts managed by at least one remote server, wherein each of the plurality of user accounts and each of the plurality of first responder accounts is associated with a corresponding personal computing (PC) device;
(B) displaying a plurality of emergency categories and a plurality of threat levels on the corresponding PC device associated with a specific user account from the plurality of user accounts through the remote server;
(C) Receiving an emergency category selection from the corresponding PC device associated with the specific user account through the remote server, wherein the emergency category selection corresponds to one of the plurality of emergency categories;
(D) Receiving a threat level selection from the plurality of threat levels for the specific emergency category from the corresponding PC device associated with the specific user account through the remote server; and
(E) Sending an emergency alert to the corresponding PC device associated with a specific first responder account from the plurality of first responder accounts through the remote server.

2. The method for providing emergency alerts as claimed in claim 1 comprising the steps of:
prompting the specific user account to enter user personal information;
prompting the specific user account to enter emergency contact information; and
receiving the personal information and emergency contact information of the specific user from the corresponding PC device through the remote serve.

3. The method for providing emergency alerts as claimed in claim 1 comprising the steps of:
prompting the specific user account to enter special needs after step (D); and
receiving the specific special needs from the corresponding PC device of the specific user account through the remote serve.

4. The method for providing emergency alerts as claimed in claim 1 comprising the steps of:
providing the specific user account with a bypass for sending the emergency alert to the specific first responder account without making emergency category selection or threat level selection through the remote server after step (B); and
relaying the emergency alert to the corresponding PC device of the specific first responder account in step (E), wherein the emergency alert comprises personal information of the specific user account without emergency category selection or threat level selection.

5. The method for providing emergency alerts as claimed in claim 5 comprising the steps of:
providing a bypass interface on the corresponding PC device of the specific user account; and
relaying the emergency alert to the corresponding PC device of the specific first responder account through the remote server, if the bypass interface is consecutively activated three times.

6. The method for providing emergency alerts as claimed in claim 1 comprising the steps of:
providing the specific first responder account with access to a camera on the PC device of the specific user account through the remote server in step (F); and
connecting the PC device of the specific first responder with the camera on the PC device of the specific user account to facilitate visual and audio communication.
